(19) United States
(12) Patent Application Publication
(10) Pub. No.: US 2008/0259987 A1
(43) Pub. Date: Oct. 23, 2008

(54) Enhanced Emission of Light From Organic Light Emitting Diodes

(75) Inventor: Euan C. Smith, Cambridge (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CAMBRIDGE DISPLAY TECHNOLOGY LIMITED, Cambridgeshire (GB)

(21) Appl. No.: 11/659,991

(22) PCT Filed: Aug. 17, 2005
(86) PCT No.: PCT/GB2005/003213

§ 371 Date: Jan. 28, 2008

(30) Foreign Application Priority Data
Aug. 17, 2004 (GB) 0418333.1

(51) Int. Cl. H01S 3/091; H01J 1/62

(52) U.S. Cl. 372/80; 313/504

(57) ABSTRACT

A device comprising an organic light emitting diode coupled to a cavity, said cavity containing an emitting species, said device being arranged such that light emitted from said organic light emitting diode is at least partially absorbed by the emitting species and re-emitted from the emitting species. The device may be arranged such that the emitting species acts as the gain media of a laser, and the organic light emitting diode may be arranged to pump the emitting species. Also provided is method of generating light, said method comprising: coupling an organic light emitting diode to a cavity, said cavity containing an emitting species, said organic light emitting diode and said cavity being arranged such that light emitted from said organic light emitting diode is at least partially absorbed by the emitting species; operating said organic light emitting diode to emit light which is at least partially absorbed by the emitting species; and re-emitting light from the emitting species.

This invention relates to light emitting devices fabricated using organic light emitting diodes.

### BACKGROUND OF OLED DEVICES

Displays fabricated using organic light emitting diodes (OLEDs) provide a number of advantages over other flat panel technologies. They are bright, colourful, fast-switching, provide a wide viewing angle and are easy and cheap to fabricate on a variety of substrates. Organic (which here includes organometallic) LEDs may be fabricated using materials including polymers, small molecules and dendrimers, in a range of colours which depend upon the materials employed. Examples of polymer-based organic LEDs are described in WO 90/13148, WO 95/06400 and WO 99/48160; examples of dendrimer-based materials are described in WO 99/21935 and WO 02/067343; and examples of so called small molecule based devices are described in U.S. Pat. No. 4,539,507.

An OLED device comprises a layer of organic light emitting material such as a light emitting polymer (LEP), oligomer or a light emitting low molecular weight material located between an anode for injection of holes and a cathode for injection of electrons. Further layers may be present, for example a layer of a hole transporting material such as a polythiophene derivative or a polyaniline derivative may be located between the anode and the light emitting material.

Organic LEDs may be deposited on a substrate in a matrix of pixels to form a single or multi-colour pixellated display. A multicoloured display may be constructed using groups of red, green, and blue emitting pixels. So-called active matrix displays have a memory element, typically a storage capacitor and a transistor, associated with each pixel whilst passive matrix displays have no such memory element and instead are repetitively scanned to give the impression of a steady image. Other passive displays include segmented displays in which a plurality of segments share a common electrode and a segment may be lit up by applying a voltage to its other electrode. A simple segmented display need not be scanned but in a display comprising a plurality of segmented regions the electrodes may be multiplexed (to reduce their number) and then scanned.

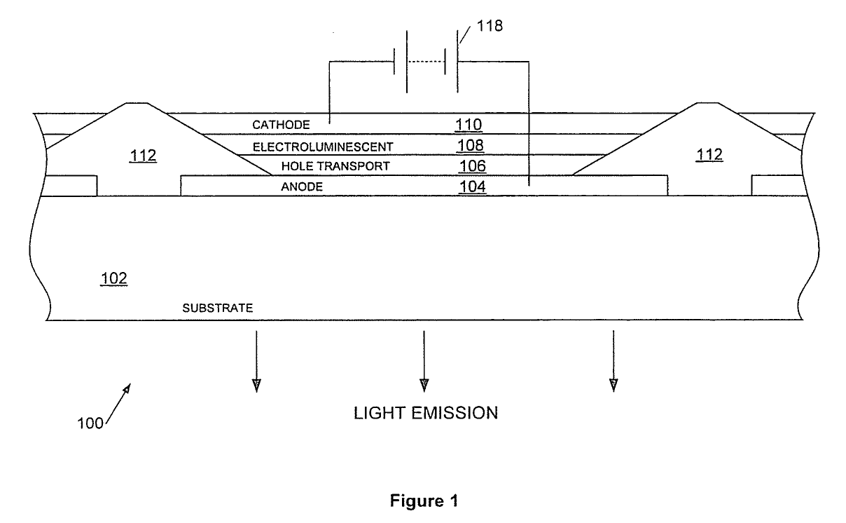

FIG. 1 shows a vertical cross section through an example of an OLED device 100. In an active matrix display part of the area of a pixel is occupied by associated drive circuitry (not shown in FIG. 1). The structure of the device is somewhat simplified for the purposes of illustration.

The OLED 100 comprises a substrate 102, typically 0.7 mm or 1.1 mm glass but optionally clear plastic or some other substantially transparent material. An anode layer 104 is deposited on the substrate, typically comprising around 150 nm thickness of ITO (indium tin oxide), over part of which is provided a metal contact layer. Typically the contact layer comprises around 500 nm of aluminium, or a layer of aluminium sandwiched between layers of chrome, and this is sometimes referred to as anode metal. Glass substrates coated with ITO and contact metal are available from Corning, USA. The contact metal over the ITO helps provide reduced resistance pathways where the anode connections do not need to be transparent, in particular for external contacts to the device. The contact metal is removed from the ITO where it is not wanted, in particular where it would otherwise obscure the display, by a standard process of photolithography followed by etching.

A substantially transparent hole transport layer 106 is deposited over the anode layer, followed by an electroluminescent layer 108, and a cathode 110. The electroluminescent layer 108 may comprise, for example, a PPV (poly(p-phenylenevinylene)) and the hole transport layer 106, which helps match the hole energy levels of the anode layer 104 and electroluminescent layer 108, may comprise a conductive transparent polymer, for example PEDOT:PSS (polystyrene-sulphonate-doped polyethylene-dioxythiophene) from H C Starck of Germany. In a typical polymer-based device the hole transport layer 106 may comprise around 200 nm of PEDOT; a light emitting polymer layer 108 is typically around 70 nm in thickness.

These organic layers may be deposited by spin coating, dip coating, doctor blade coating (afterwards removing material from unwanted areas by plasma etching or laser ablation). Alternatively selective deposition techniques wherein the organic material is only deposited in desired areas, such as inkjet printing or laser induced thermal imaging (LITI), may be employed. In the case of inkjet printing, banks 112 may be formed on the substrate, for example using photoresist, to define wells into which the organic layers may be deposited. Such wells define light emitting areas or pixels of the display.

Cathode layer 110 typically comprises a low work function metal (typically less than 3.5 eV, more preferably less than 3.0 eV) such as calcium or barium (for example deposited by physical vapour deposition or sputtering) covered with a thicker, capping layer of aluminium. Optionally an additional layer may be provided immediately adjacent the electroluminescent layer, such as a layer of lithium fluoride, for improved electron energy level matching. Mutual electrical isolation of cathode lines may achieved or enhanced through the use of cathode separators (not shown in FIG. 1).

The same basic structure may also be employed for small molecule devices wherein the light emitting material is typically deposited by vacuum evaporation.

Typically a number of displays are fabricated on a single substrate and at the end of the fabrication process the substrate is scribed, and the displays separated before an encapsulating can is attached to each to inhibit oxidation and moisture ingress.

To illuminate the OLED power is applied between the anode and cathode, represented in FIG. 1 by battery 118. In the example shown in FIG. 1 light is emitted through transparent anode 104 and substrate 102 and the cathode is generally reflective; such devices are referred to as “bottom emitters”. Devices which emit through the cathode (“top emitters”) may also be constructed, for example by keeping the thickness of cathode layer 110 less than around 50-100 nm so that the cathode is substantially transparent.

Organic LEDs may be deposited on a substrate in a matrix of pixels to form a single or multi-colour pixellated display. A multicoloured display may be constructed using groups of red, green, and blue emitting pixels. In such displays the individual elements are generally addressed by way of an active matrix or passive matrix as described above.

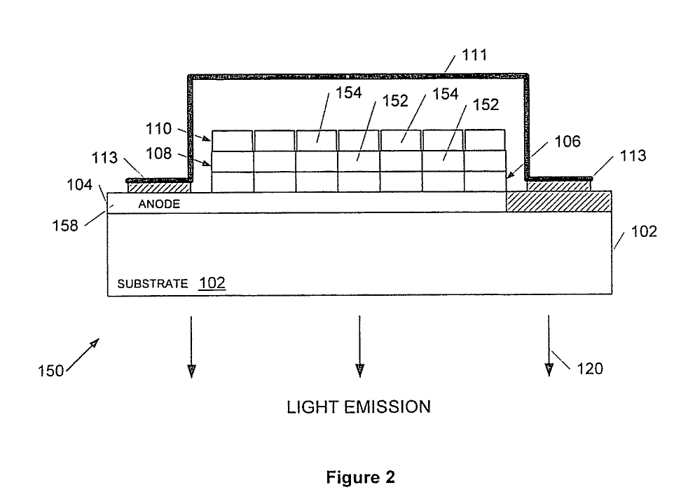

Referring now to FIG. 2, this shows a simplified cross-section through a passive matrix OLED display device 150, in which like elements to those of FIG. 1 are indicated by like reference numerals. As shown the hole injection 106 and electroluminescent 108 layers are subdivided into a plurality of pixels 152 at the intersection of mutually perpendicular anode and cathode lines defined in the anode 104 and cathode layer 110 respectively. In the figure conductive lines 154 defined in the cathode layer 110 run into the page and a cross-section through one of a plurality of anode lines 158 running at right angles to the cathode lines is shown. An electroluminescent pixel 152 at the intersection of a cathode and anode line may be addressed by applying a voltage between the relevant lines. The anode metal layer 104 provides external contacts to the display 150 and may be used for both anode and cathode connections to the OLEDs (by running the cathode layer pattern over anode metal lead-outs).

The above mentioned OLED materials, and in particular the light emitting polymer material and the cathode, are susceptible to oxidation and to moisture. The device is therefore often encapsulated in a metal can 111, attached by UV-curable epoxy glue 113 onto anode metal layer 104, small glass beads within the glue preventing the metal can touching and shorting out the contacts. Preferably the anode metal contacts are thinned where they pass under the lip of the metal can 111 to facilitate exposure of glue 113 to UV light for curing.

### The Problem of Total Internal Reflection in OLED Devices

A problem with OLED devices in general is that often only 20-30% of the light that is generated by the OLED device is actually emitted towards the viewer. The rest of the light that is generated is wasted, due to the effects of total internal reflection. It is a well known optical principle that when light is transmitted through an optical medium adjacent to air, the higher the refractive index of the optical medium, the smaller the critical angle above which total internal reflection will occur within the optical medium. In OLED devices the generated light is transmitted through a substrate having a high refractive index, which (in the case of a typical polymer substrate) gives a critical angle of approximately 40°. Thus, rays which pass through the polymer towards the air at an angle of incidence of greater than 40° are totally internally reflected and are thereby wasted.

It is desirable to minimise the amount of generated light that is wasted due to the effects of total internal reflection, and thereby increase the efficiency of the OLED device and enhance the quantity of light that may usefully be extracted.

According to a first aspect of the present invention there is provided a device comprising an organic light emitting diode coupled to a cavity, said cavity containing an emitting species, said device being arranged such that light emitted from said organic light emitting diode is at least partially absorbed by the emitting species and re-emitted from the emitting species. Absorbing the light generated by the OLED and re-emitting it provides the advantage that more useful light is output from the device, compared with conventional OLEDs in which a substantial amount of light is wasted. This accordingly improves the efficiency of the device. A further advantage is that it is possible to achieve highly directional emission of light from the emitting species.

The term “organic light emitting diode” as used herein should be interpreted broadly, to include organometallic light emitting diodes.

Preferably the emitting species is a phosphor.

By “phosphor” is meant a material capable of absorbing and re-emitting light. A wide range of suitable emitting species will be apparent to the skilled person including fluorescent or phosphorescent, inorganic or organic materials (it will be appreciated that “phosphors” are not limited to phosphorescent materials). Examples of suitable emitters include fluorescent laser dyes (e.g. rhodamine) and phosphorescent organometallic compounds, for example dendrimers as disclosed in WO 02/066552.

The emitter may be dispersed in an inert matrix, e.g. polymethyl methacrylate (PMMA).

Preferably the cavity is formed by one or more dielectric Bragg layers. Particularly preferably the cavity is formed between a first dielectric Bragg reflector and a second dielectric Bragg reflector.

In a preferred embodiment the first and second dielectric Bragg reflectors are situated between the substrate and the anode of the organic light emitting diode. Preferably the first dielectric Bragg reflector is situated adjacent the substrate and is configured to reflect substantially 100% of the light emitted by the organic light emitting diode, and to reflect a portion and transmit a portion of the light generated by the emitting species.

Preferably the second dielectric Bragg reflector is situated adjacent the anode and is configured to transmit substantially all of the light emitted by the organic light emitting diode, and to reflect approximately 100% of the light generated by the emitting species.

Alternatively, the cavity may be formed by patterning.

The device may be arranged to provide emission of light in the plane of the cavity. Such emission is advantageously highly directional.

Light re-emitted from the emitting species may be used to form a pixel in a visual display.

Alternatively, the device may be arranged such that the emitting species acts as the gain media of a laser. The organic light emitting diode may be arranged to pump the emitting species. The laser may be arranged to provide forward emission or edge emission of a laser beam.

According to a second aspect of the present invention there is provided a method of generating light, said method comprising: coupling an organic light emitting diode to a cavity, said cavity containing an emitting species, said organic light emitting diode and said cavity being arranged such that light emitted from said organic light emitting diode is at least partially absorbed by the emitting species; operating said organic light emitting diode to emit light which is at least partially absorbed by the emitting species; and re-emitting light from the emitting species.

The re-emitted light from the emitting species may form a pixel in a visual display.

Alternatively, the method may further comprise arranging the emitting species to act as the gain media of a laser. The method may still further comprise arranging the organic light emitting diode to pump the emitting species.

Such a laser may be used as a distributed feedback laser for use in telecommunications, or in local area networks.

Further aspects of the invention provide a display device and a laser incorporating a device in accordance with the first aspect of the invention.

Embodiments of the invention will now be described, by way of example only, and with reference to the drawings in which:

FIG. 1 illustrates a vertical cross section through a typical OLED device;

FIG. 2 illustrates a cross-section through a passive matrix OLED device;

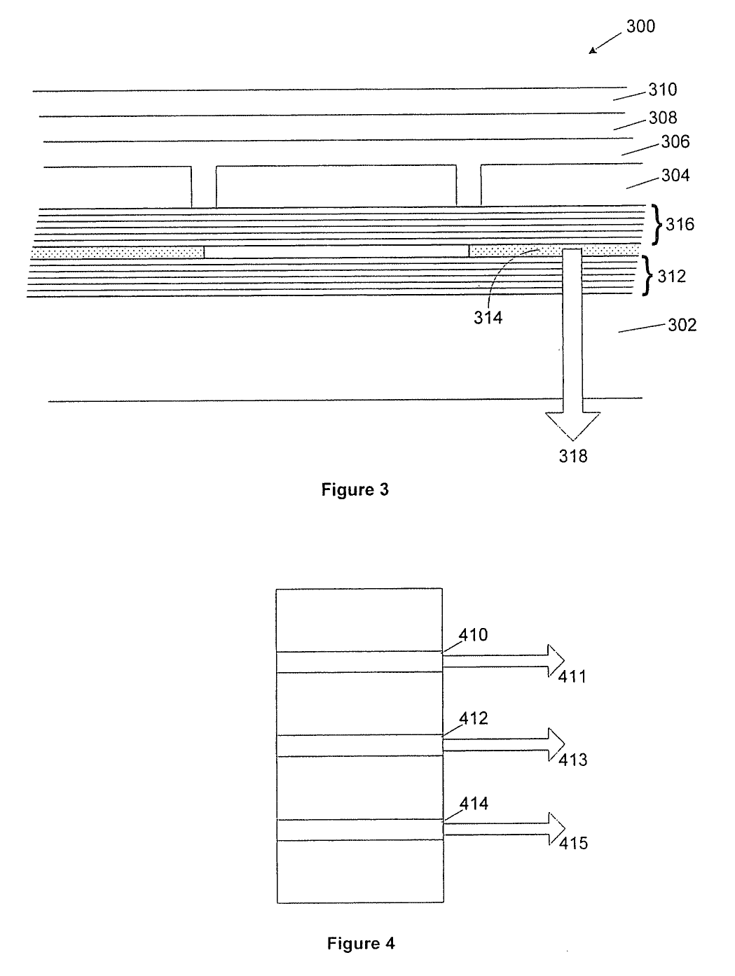

FIG. 3 illustrates a vertical cross section through an OLED device having two dielectric Bragg reflectors and a microcavity phosphor, giving emission of light from the phosphor normal to the plane of the phosphor;

FIG. 4 illustrates a vertical cross section through a device providing edge emission of light from a series of microcavity phosphor pixels;

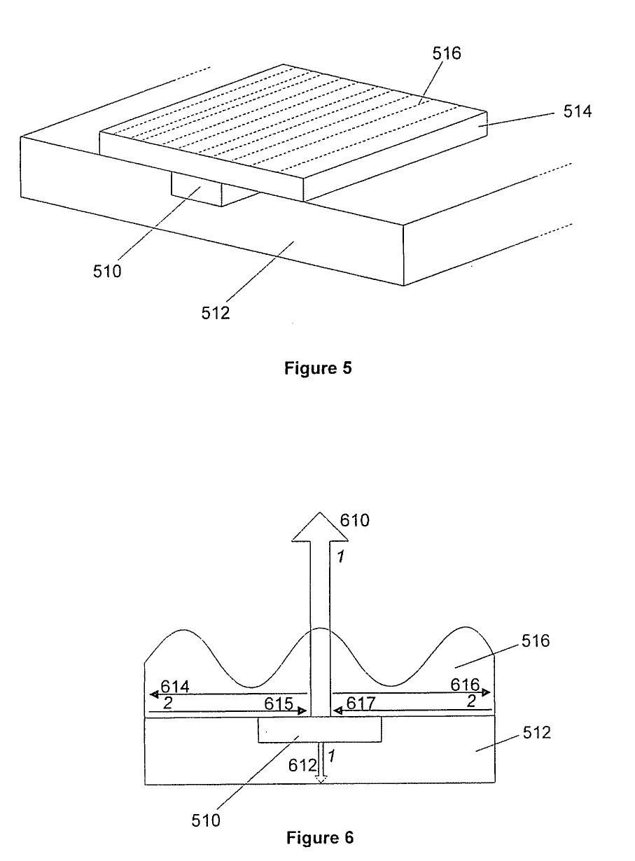

FIG. 5 illustrates an OLED device being used as a pump source for a polymer film having a dimpled surface to cause lasing;

FIG. 6 illustrates an OLED device being used as a pump source to form a forward emission laser;

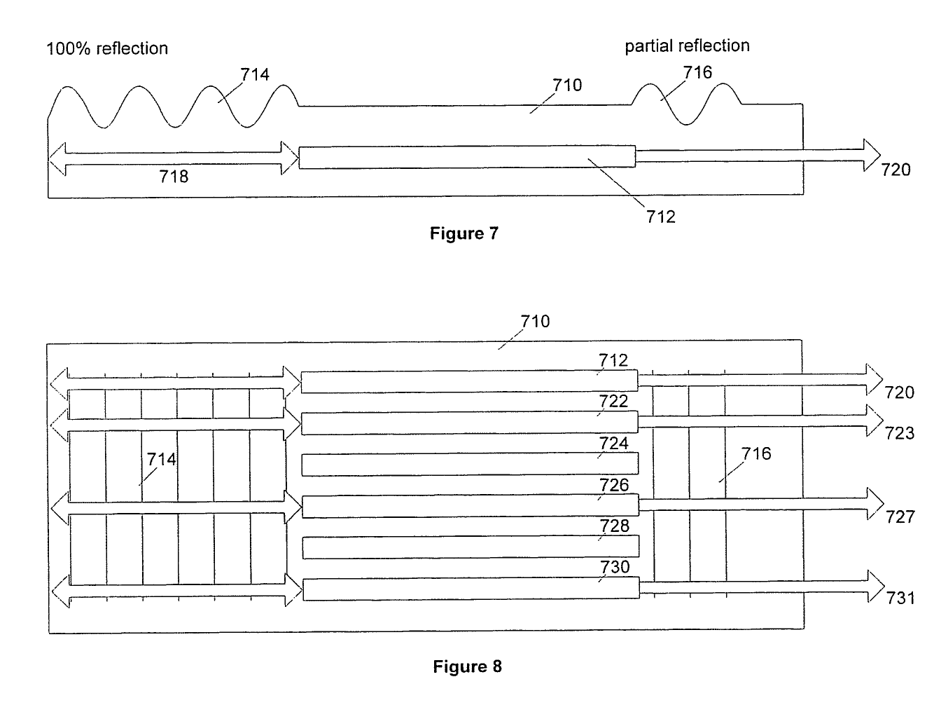

FIG. 7 illustrates in cross section an OLED device being used as a pump source for an edge emission laser;

FIG. 8 illustrates in plan view a series of OLED devices being used as pump sources for a series of edge emission lasers; and

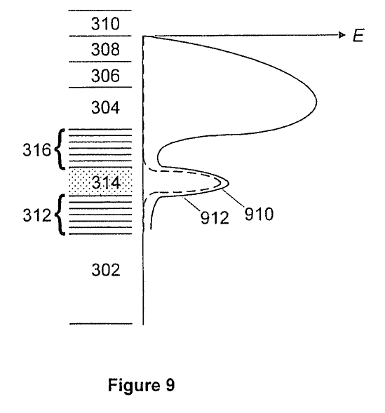

FIG. 9 illustrates schematically the desired correspondence between the emission mode profile of light emitted from an OLED device and the absorption profile of a microcavity phosphor, to achieve efficient transfer of energy from an OLED device to a microcavity phosphor.

In the figures, like elements are indicated by like reference numerals throughout. The thicknesses of the layers shown in the figures are not to scale.

The present embodiments represent the best ways known to the applicant of putting the invention into practice. However they are not the only ways in which this can be achieved.

Rather than using an OLED device directly as an emitter, the present embodiments use an OLED as a pump for a further component. Close-coupled phosphors are provided in microcavities arranged to transfer light from the OLED to the phosphor. The light absorbed by the microcavity phosphor is then re-emitted. In this manner, a greater quantity of light may be extracted, compared with instances in which an OLED is used directly as an emitter. Additionally it is possible to achieve highly directional emission from the phosphor.

Background information on the use of optical microcavities as light emitters may be found in U.S. Pat. No. 5,478,658.

As shown in FIG. 3, a first embodiment 300 comprises a glass substrate 302, a first dielectric Bragg reflector (DBR) 312 (also known as a “Bragg stack”), a microcavity phosphor 314, a second DBR 316, an ITO anode 304, a PEDOT hole transport layer 306, a light emitting polymer (LEP) electroluminescent layer 308, and a cathode 310. The anode 304, PEDOT layer 306, LEP layer 308 and cathode 310 form an OLED device that is close-coupled to the microcavity phosphor 314. The OLED device 304, 306, 308, 310 is arranged to pump the phosphor 314, and light is emitted in the direction indicated by arrow 318.

The microcavity is defined by the gap between the Bragg reflectors 312 and 316, and contains the microcavity phosphor 314. The thickness of the microcavity (i.e. the distance between the reflectors 312 and 316) will be readily apparent to the skilled person. Computer modelling may be employed to optimise the thickness of the microcavity to allow for distributed reflections.

In principle, any phosphor (e.g. as typically used for plasma screen displays or fluorescent lighting) may be used to form the microcavity phosphor 314. Candidate materials include laser dyes (e.g. rhodamine) doped in a transparent matrix (e.g. poly(methyl methacrylate) (PMMA)) to prevent aggregation. Desirable phosphor requirements are a good susceptibility to optical pumping (rather than electrical pumping), high photoluminescence (PL) efficiency, good transparency to emitted wavelengths, and relatively high absorbance above the bandgap.

The first Bragg reflector 312 is preferably configured to reflect 100% of the light generated by the OLED (i.e. light of wavelength λOLED), and to reflect a portion and transmit a portion of the light generated by the phosphor 314 (i.e. light of wavelength λPHOSPHOR) The high reflectivity (ideally 100%) of the first Bragg reflector 312 to light of wavelength λOLED improves the efficiency of the coupling between the OLED and the microcavity phosphor, as any light generated by the OLED that is not absorbed in its first pass through the phosphor is reflected back into the phosphor, providing a further opportunity for the OLED light to be absorbed by the phosphor.

The second Bragg reflector 316 is preferably configured to reflect 100% of light of wavelength λPHOSPHOR, and 0% (i.e. complete transmission) of light of wavelength λOLED. This configuration enables all the light generated by the OLED to enter the microcavity, and none of the light generated by the phosphor to escape through the reflector 316, thereby further enhancing the efficiency of the coupling between the OLED and the phosphor.

The use of DBRs is well known in the field of laser design to achieve a directional output. Here, the optical structure of the microcavity and surrounding Bragg reflectors 312, 316 is preferably such that the intensity of the optical mode is maximised at the light emitting species. As will be apparent to the skilled person, a high-q cavity may be preferable for certain applications.

An array of OLED pixels may be used with a corresponding array of microcavity phosphors to produce an array of pixels in a visual display having high light output. A phosphor surrounded by a micro-cavity is placed under an array of OLED pixels. As will be apparent to the skilled person, a high-q cavity may be preferable for certain applications. For an RGB array of pixels, the light emitting polymer may be blue and the phosphors may be patterned in a red, green and blue configuration. The array is arranged such that the phosphor absorbs most of the light generated by the OLED pixels (not just the fraction which would escape into the air) and the absorbed light is emitted with well defined directional properties.

FIG. 4 illustrates schematically a portion of a series or array of edge emitting microcavity phosphor pixels, in which three edge-emitting microcavity phosphors 410, 412, 414 are independently operable to produce directional edge-emitted rays of light 411, 413, 415.

Microcavity phosphors may also be used to generate lasers. Both forward emission and edge emission lasers may be formed. FIGS. 5 and 6 illustrate possible arrangements to achieve forward emission lasing, and FIGS. 7 and 8 illustrate possible arrangements for edge emission lasing.

Firstly with reference to FIG. 5, a polymer film 514 may be deposited on a glass substrate 512 in which an OLED and microcavity phosphor 510 are situated. The upper surface of the polymer film 514 is provided with a pattern of dimples, shaped in a sinusoidal manner such that the polymer sheet effectively acts as a Bragg grating. The microcavity phosphor 510 effectively acts as a pump source for a forward emission laser. As shown in FIG. 6, the OLED and microcavity phosphor emit a first order light output 610 through the polymer film, in the “1” direction. A small amount of light 612 may be emitted in the opposite direction. Second order light rays 614, 616 emitted perpendicularly, in the “2” directions, are reflected back (rays 615, 617) towards the microcavity phosphor. These rays combine coherently to provide lasing in the primary “1” direction 610.

FIGS. 7 and 8 are schematic cross-sectional and plan views respectively, illustrating a series of OLED/microcavity phosphor pump sources 712, 722, 724, 726, 728, 730 used to produce a series of independently-operable edge emission lasers. In the example shown in FIG. 8, sources 712, 722, 726 and 730 are activated, to generate output laser beams 720, 723, 727 and 731 respectively.

As shown in FIG. 7, phosphor 712 is pumped by an OLED (not shown). The material 710 in which the phosphor 712 is located is patterned laterally to the substrate to form a sinusoidal profile in regions 714 and 716. The material 710 may be a polymer that is patterned by methods well known to the skilled person. For example, the polymer may be patterned by embossing. Region 714 is configured so that 100% of the light that is emitted from the phosphor 712 in the direction of region 714 is reflected back towards the phosphor 712 (the outward and reflected light being indicated by arrow 718 in FIG. 7). Region 716 is arranged to give partial reflection back towards the pump source 712. The light rays that are reflected back towards the phosphor 712 combine coherently to provide edge emission 720. The necessary optical thickness of the laterally patterned regions will be apparent to the skilled person. The phosphor 712 could be laterally patterned as an alternative to, or in addition to, lateral pattering of material 710.

To improve the efficiency of the microcavity phosphor, a metal mirror may be provided on the side of the phosphor remote from the OLED to reflect light not absorbed in the first pass through the phosphor.

Both forward emission and edge emission lasers obtained using OLEDs and microcavity phosphors may be designed as narrow band distributed feedback lasers (DFBs), for example for telecommunications applications.

As those skilled in the art will appreciate, to ensure efficient operation of these devices it is desirable to have strong coupling between the emission profile of the OLED and the optical absorption (pumping) profile of the light emitting species. This is illustrated schematically in FIG. 9. A cross section through the OLED and microcavity phosphor of FIG. 3 is shown on the left of FIG. 9, using the same reference numerals as in FIG. 3. Alongside the representation of the OLED (304, 306, 308, 310), DBRs 312, 316 and microcavity phosphor 314 is a plot illustrating variations in field strength E with position through the OLED, DBRs and microcavity phosphor, for both light emitted from the OLED and light emitted by the microcavity phosphor. The variation in field strength E with position for light emitted from the OLED is represented by the solid line, and the variation in field strength E with position for light emitted by the microcavity phosphor 314 is represented by the dashed line. As illustrated, it is desirable for the emission mode profile of the light emitted by the OLED device 910 to match the absorption profile 912 of the microcavity phosphor 314 to achieve efficient coupling between the OLED and the microcavity phosphor.

1. A device comprising an organic light emitting diode coupled to a cavity, said cavity containing an emitting species, said device being arranged such that light emitted from said organic light emitting diode is at least partially absorbed by the emitting species and re-emitted from the emitting species.

2. A device as claimed in claim 1, wherein the emitting species is a phosphor.

3. A device as claimed in claim 2, wherein the phosphor is a laser dye in a matrix.

4. A device as claimed in claim 3, wherein the laser dye is rhodamine.

5. A device as claimed in claim 3, wherein the matrix is PMMA.

6. A device as claimed in claim 1, wherein the cavity is formed by one or more dielectric Bragg layers.

7. A device as claimed in claim 6, wherein the cavity is formed between a first dielectric Bragg reflector and a second dielectric Bragg reflector.

8. A device as claimed in claim 7, wherein the first and second dielectric Bragg reflectors are situated between the substrate and the anode of the organic light emitting diode.

9. A device as claimed in claim 8, wherein the first dielectric Bragg reflector is situated adjacent the substrate and is configured to reflect substantially 100% of the light emitted by the organic light emitting diode.

10. A device as claimed in claim 9, wherein the first dielectric Bragg reflector is further configured to reflect a portion and transmit a portion of the light generated by the emitting species.

11. A device as claimed in claim 8, wherein the second dielectric Bragg reflector is situated adjacent the anode and is configured to transmit substantially all of the light emitted by the organic light emitting diode.

12. A device as claimed in claim 11, wherein the second dielectric Bragg reflector is further configured to reflect approximately 100% of the light generated by the emitting species.

13. A device as claimed in claim 1, wherein the cavity is formed by patterning.

14. A device as claimed in claim 1, arranged to provide emission of light in the plane of the cavity.

15. A device as claimed in claim 1, arranged such that light re-emitted from the emitting species forms a pixel in a visual display.

16. A device as claimed in claim 1, arranged such that the emitting species acts as the gain media of a laser.

17. A device as claimed in claim 16, wherein the organic light emitting diode is arranged to pump the emitting species.

18. A device as claimed in claim 16, wherein the laser is arranged to provide forward emission of a laser beam.

19. A device as claimed in claim 16, wherein the laser is arranged to provide edge emission of a laser beam.

20. A method of generating light, said method comprising:
coupling an organic light emitting diode to a cavity, said cavity containing an emitting species, said organic light emitting diode and said cavity being arranged such that light emitted from said organic light emitting diode is at least partially absorbed by the emitting species;
operating said organic light emitting diode to emit light which is at least partially absorbed by the emitting species; and
re-emitting light from the emitting species.

21. A method as claimed in claim 20, wherein the re-emitted light from the emitting species forms a pixel in a visual display.

22. A method as claimed in claim 20, further comprising arranging the emitting species to act as the gain media of a laser.

23. A method as claimed in claim 22, further comprising arranging the organic light emitting diode to pump the emitting species.

24. A method as claimed in claim 22, wherein the laser is arranged to provide forward emission of a laser beam.

25. A method as claimed in claim 22, wherein the laser is arranged to provide edge emission of a laser beam.

26. A display device incorporating a device as claimed in claim 1.

27. A laser incorporating a device as claimed in claim 1.

28. (canceled)

29. (Canceled)

30. A device as claimed in claim 4, wherein the matrix is PMMA.

31. A device as claimed in claim 9, wherein the second dielectric Bragg reflector is situated adjacent the anode and is configured to transmit substantially all of the light emitted by the organic light emitting diode.

32. A device as claimed in claim 10, wherein the second dielectric Bragg reflector is situated adjacent the anode and is configured to transmit substantially all of the light emitted by the organic light emitting diode.

33. A device as claimed in claim 17, wherein the laser is arranged to provide forward emission of a laser beam.

34. A device as claimed in claim 17, wherein the laser is arranged to provide edge emission of a laser beam.

35. A method as claimed in claim 23, wherein the laser is arranged to provide forward emission of a laser beam.

36. A method as claimed in claim 23, wherein the laser is arranged to provide edge emission of a laser beam.
